(19) United States
(12) Patent Application Publication
(10) Pub. No.: US 2025/0029518 A1
(43) Pub. Date: Jan. 23, 2025

(54) Magnetic Retention Device for Displaying Collectibles

(71) Applicant: Brian Andrew Brader, Ballston Lake, NY (US)

(72) Inventor: Brian Andrew Brader, Ballston Lake, NY (US)

(21) Appl. No.: 18/645,422

(22) Filed: Apr. 25, 2024

Related U.S. Application Data
(60) Provisional application No. 63/514,986, filed on Jul. 21, 2023.

(51) Int. Cl. G09F 1/12

(52) U.S. Cl. CPC G09F 1/12

(57) ABSTRACT

The present disclosure relates to a retention device for displaying protective cases, particularly for collectible trading cards. The device comprises a body with a back plate that defines a flat vertical surface. This body features a first top end and an opposing bottom end, each equipped with retaining structures. The first top end includes at least one first retaining structure designed to support the top edge of a protective case when installed flush against the back plate. The opposing bottom end similarly includes at least one second retaining structure for supporting the bottom edge of the installed protective case. Additionally, the back plate incorporates at least one cavity intended to house a magnetic element. This magnetic element is strategically positioned to align with a corresponding metallic or magnetic element of the protective case, facilitating a secure and aesthetically pleasing display.

### CROSS-REFERENCE TO RELATED APPLICATIONS

This application claims priority to U.S. Provisional Application No. 63/514,986, filed on Jul. 21, 2023. The entirety of the aforementioned provisional application is hereby incorporated by reference for all purposes.

### FIELD OF INVENTION

The present invention relates generally to the field of display systems for collectibles, specifically to a device designed to hold and display protective cases for collectible trading cards and similarly shaped items in a manner that is both visually appealing and protective.

### BACKGROUND

The realm of collectible trading cards is marked by enthusiasts' deep appreciation for both the intrinsic and aesthetic value of their collections. Preserving the pristine condition of these cards while simultaneously displaying them in an appealing manner poses a considerable challenge with current methods. Traditional approaches, such as framing or adhering cards to surfaces, have several drawbacks. Frames often limit the flexibility needed to frequently swap cards, and the use of adhesives can lead to permanent damage to both the card and its protective casing, detracting from the item's visual and material value.

Moreover, while “one touch” protective display cases have become popular for their ability to shield collectibles from physical damage, they lack functionality in terms of display. These cases, although effective in protection, do not support wall or shelf mounting, limiting the display options for collectors. The cases usually consist of two transparent rectangular panels held together by a central metallic or magnetic closure, providing no means for easy integration into an aesthetic display setup.

Examples of one touch display cases and known mounting systems include prior art patent publication U.S. Pat. No. 10,847,060B1, which relates to a trading card display assembly for securely displaying trading cards that includes a plurality of hanger units.

Another example can be found in prior art patent publication US2004154204A1, which describes a protective display holder for a flat item, such as a collectible card or a photograph, comprising a substantially rigid base having a flat top surface and a recess from the flat surface for receiving the flat item; a substantially rigid cover having a flat bottom surface; and at least one magnetic member affixed to the base, and at least one magnetic member affixed to the cover and magnetically attracted to the at least one magnetic member affixed to the base for urging the bottom surface of the cover against the top surface of the base.

The mounting systems available for such protective cases often complicate the display process. These systems can be bulky, visually unappealing, and obstructive, which not only affects the overall presentation but also makes the swapping of cards a cumbersome and frustrating task. Collectors are thus forced to choose between accessibility and aesthetics, often sacrificing one for the other.

There is a clear necessity for a display device that accommodates the protective cases used by collectors without compromising on ease of use, aesthetic appeal, and the overall integrity of the collectible. Such a device would ideally allow for the cards to remain the focal point of the display, with minimal to no surrounding distractions or obstructions, and would enable collectors to effortlessly change their displayed items as desired. This need underlines the development of a new solution that addresses these shortcomings while enhancing the user experience, preserving the quality of collectibles, and providing a visually pleasing and practical display option.

It is within this context that the present invention is provided.

### SUMMARY

The invention relates to a retention device designed for displaying a protective case. This device includes a body with a back plate that defines a flat vertical surface, a first top end, and an opposing bottom end. The first top end incorporates at least one first retaining structure to support the top edge of the protective case when installed flush against the back plate, while the opposing bottom end includes at least one second retaining structure to support the bottom edge of the installed protective case. The back plate is equipped with at least one cavity, within which at least one magnetic element is configured to be installed. This magnetic element is strategically positioned to align with a metallic or magnetic element of the protective case when the case is installed against the back plate, ensuring a secure and stable display.

In some embodiments, the at least one cavity is designed to receive a removable magnetic element. This feature allows for the adjustment of the magnetic element's orientation, providing versatility to accommodate protective cases from different manufacturers or with varying magnetic configurations.

In other embodiments, the at least one cavity is an opening in which the at least one magnetic element is permanently installed, offering a simplified and durable construction that reduces the need for additional adjustments or alignments after installation.

Further, the device may include one or more additional cavities and corresponding magnetic elements to accommodate different styles of protective cases and to adjust the level of attractive force between the retention device and the protective case. This customization enhances the device's utility across a broad range of protective case designs and sizes.

The retention device may also include various retaining structures such as shelves, ledges, support pegs, or hooks as part of the first and second retaining structures. These components add structural diversity, allowing for secure support of protective cases of different dimensions and designs.

In some embodiments, the body of the retention device is made from materials selected from a group consisting of metal and plastic, offering a balance between durability and weight, which is critical for wall-mounted or freestanding display setups.

Additionally, the device may incorporate a stand, adhesive strip, or other mounting hardware on the opposing side of the back plate for easy mounting to a wall or other vertical surface. This feature facilitates versatile placement and secure installation in various display environments.

In certain configurations, the body of the device is substantially rectangular, and the arrangement of the first top end and the opposing bottom end is specifically designed to maintain the card as the centerpiece of the display, focusing attention on the collectible item without visual interference.

The back plate may include an aperture to facilitate manual dislodging of the protective case, enhancing user convenience by enabling easier removal and replacement of the displayed items.

The device is also configured to display flat planar objects other than trading card protective cases, such as artworks and photographs, broadening the applicability of the device beyond collectible cards.

In some embodiments, the magnetic elements are composed of neodymium. This choice of material provides a strong magnetic force essential for securely holding the protective case against the back plate.

Moreover, the body and its components may be coated with a corrosion-resistant finish, which enhances both the longevity and visual appearance of the device, ensuring that it remains both functional and aesthetically pleasing over time.

Lastly, parts of the body may be manufactured from transparent acrylic materials to minimize visual obstruction and maintain focus on the displayed protective case, preserving the aesthetic integrity of the displayed items.

### BRIEF DESCRIPTION OF THE DRAWINGS

Various embodiments of the invention are disclosed in the following detailed description and accompanying drawings.

FIG. 1 illustrates an example front view of the first embodiment of the retention device showing the complete setup with protective case positioning.

FIG. 2 illustrates an example perspective view of the first embodiment of the retention device, highlighting the device's overall structure and mounting features.

FIG. 3 illustrates an example side view of the first embodiment of the retention device, detailing the alignment and support mechanisms for a protective case.

FIG. 4 illustrates an example of the removable piece that fits into the cavity at the top end of the retention device, designed to hold a magnet in a desired orientation.

FIG. 5 illustrates an example front view of the second embodiment of the retention device, showing the one-piece configuration with integrated legs for support.

FIG. 6 illustrates an example top-down view of the second embodiment of the retention device, focusing on the layout of legs and ledges for stability and support.

FIG. 7 illustrates an example perspective view of the second embodiment, emphasizing the device's ergonomic features and simplicity of design.

FIG. 8 illustrates an example side view of the second embodiment, detailing the integration of the magnet and the ergonomic aperture for ease of use.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

For the purposes of this disclosure, the term “body” refers to the main structure of the retention device that includes a back plate and retaining structures. The “back plate” is a flat vertical surface upon which the protective case is mounted. The terms “first top end” and “opposing bottom end” refer to the upper and lower bounds of the body, respectively, each equipped with structures for supporting the protective case.

The “first retaining structure” and “second retaining structure” are components of the body that directly interact with the protective case to hold it in place. These structures can vary in form, including but not limited to, shelves, ledges, support pegs, or hooks. The choice of structure depends on the specific requirements for supporting the protective case, such as weight, size, and the material of the case.

The term “cavity” refers to a recessed area within the back plate designed to accommodate a “magnetic element.” This magnetic element is intended to interact with a corresponding metallic or magnetic component on the protective case, aligning and securing the case against the back plate.

The body of the retention device may be constructed from various durable materials such as metals (e.g., aluminum, steel), plastics (e.g., polycarbonate, ABS plastic), or composites thereof. The selection of material can be influenced by factors such as durability, weight, cost, and aesthetic considerations.

The magnetic element can be made from neodymium, which is known for its strong magnetic properties, or other suitable magnetic materials such as ferrite. The choice of magnet type can be determined based on the required magnetic strength, environmental resistance, and cost.

The retention device may include various attachment mechanisms for mounting to a wall or other surfaces. These can include adhesive strips, mounting hardware such as screws and wall anchors, or integrated stands for freestanding display. The specific attachment mechanism chosen will depend on the intended use environment, the weight of the device and the protective case, and user preferences for installation ease and security.

### DESCRIPTION OF DRAWINGS

The present invention relates generally to devices for displaying collectible items, and more specifically to a retention device designed to display protective cases that house collectible trading cards or similarly shaped items. This retention device aims to provide a secure and aesthetically pleasing means of displaying collectibles while allowing for easy access and interchangeability of the displayed items.

The invention comprises a body featuring a back plate, which acts as the main structural component. The back plate is configured with a flat vertical surface against which the protective case is mounted. Distinctive features of the body include a first top end and an opposing bottom end, each equipped with retaining structures that support and secure the top and bottom edges of the protective case, respectively. These retaining structures are designed to hold the protective case flush against the back plate, providing a clean and unobstructed view of the collectible item.

Central to the functionality of the retention device is the inclusion of at least one cavity within the back plate. This cavity is specifically designed to house a magnetic element. The magnetic element is crucial as it aligns with and interacts with a corresponding metallic or magnetic element on the protective case. This interaction ensures that the protective case is held securely against the back plate, thereby stabilizing the display and preventing accidental dislodgement of the collectible.

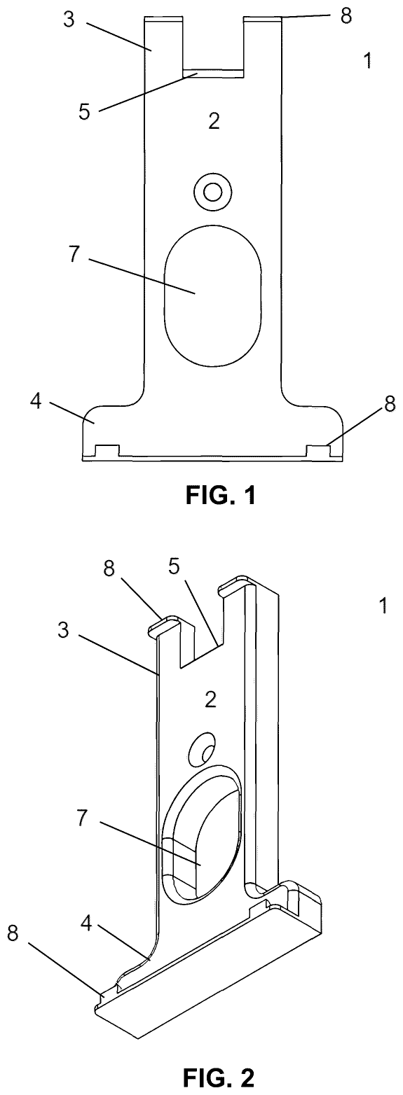

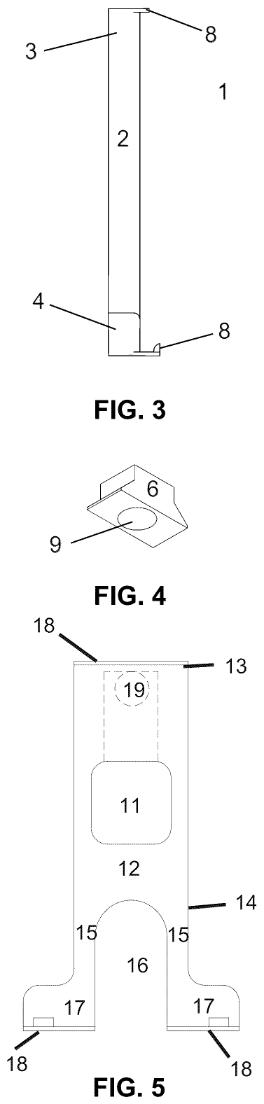

FIGS. 1 through 4 depict a first example embodiment of a retention device designed to display protective cases for collectible cards or similarly shaped flat planar objects. These figures show isometric views of the device from the front, perspective, and side.

The device 1, features a substantially rectangular planar body 2. This body is crafted to have a flat vertical surface, referred to as the back plate, which extends between a first top end 3, and an opposing second end 4. The back plate is designed to support the entire back surface of a collectible card protective case in a manner that ensures the case lies flush against it, thus providing a stable and visually appealing display.

Located at the top end 3 of the body 2 is a square cavity 5, which serves to divide the top edge of the retention device into two segments, enhancing the structural integrity and to receive a removable piece 6, as illustrated in FIG. 4. This removable piece includes its own cavity designed to hold a magnet 9. The magnet housed within this removable piece can be oriented as needed to align precisely with the magnetic or metallic elements on the protective case, thereby securing the case in place.

A ledge 8 is formed at the first top end 3 of the body 2. This ledge acts as a support for the top edge of the protective case when it is mounted against the vertical surface of the body, ensuring that the case is held securely and does not shift or slide downwards.

Additionally, the body 2 incorporates a rounded square aperture 7, positioned midway along its length. This aperture is designed to facilitate ease of handling, providing a grip point for users. Moreover, this feature allows a user to easily dislodge an installed protective case by simply pushing a finger through the aperture, offering a straightforward method for changing displays without the need for additional tools or force.

The materials chosen for the construction of the device can vary based on specific needs and preferences. Typically, the body is made from durable materials such as metals or high-grade plastics, which provide both strength and a pleasing aesthetic. Metals such as aluminum or stainless-steel offer durability and a premium look, while plastics like acrylic can be used for a lighter, more cost-effective option. The magnetic elements are preferably made from strong magnetic materials such as neodymium, which ensures a firm hold on the protective case through magnetic attraction.

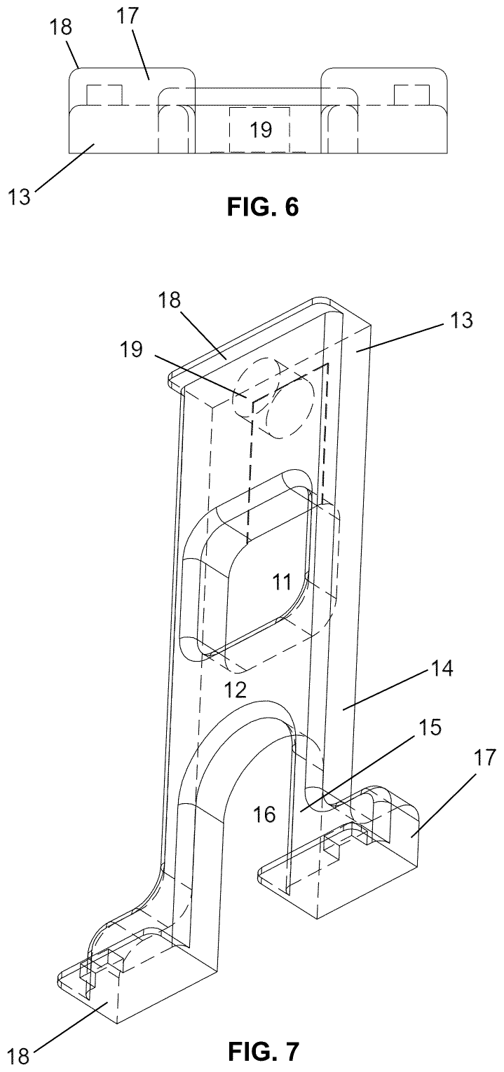

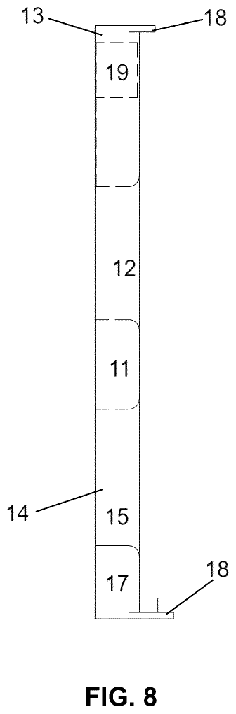

FIGS. 5 through 8 present an alternative second embodiment of the retention device, showcasing a simpler design that integrates a one-piece configuration. This embodiment, identified as device 10, includes a substantially rectangular planar body 12, which simplifies the assembly and maintenance of the device compared to the first embodiment.

The planar body 12 of device 10 extends between a first end 13 and an opposing second end 14. Notably, this version incorporates a pair of legs 15 emanating longitudinally from the lower end, which form an inverted U-shaped aperture 16.

The legs 15 are designed to widen laterally as they extend away from the body 12, culminating in feet 17. Each foot includes a ledge 18, which functions similarly to the ledge in the first embodiment by supporting the bottom edge of the protective case. This ensures that the protective case remains securely positioned against the vertical surface of the body 12. An additional ledge 18 at the first end 13 further stabilizes the top edge of the protective case, maintaining its alignment and preventing any slippage.

Embedded within the body 12 near the first end 13 is a magnet 19. Unlike the first embodiment, where the magnet could be repositioned within a removable piece, this magnet is permanently set within the body, reducing the complexity of the device while still effectively securing the protective case against the back plate. This permanent embedding of the magnet simplifies the manufacturing process and potentially reduces the cost of production.

Another ergonomic feature of this embodiment is the inclusion of a rounded square aperture 11, located midway along the body. As with the first embodiment, this aperture provides a grip point for users, making the device easier to handle and manipulate.

To facilitate easy installation, device 10 can be mounted to a wall or other vertical surfaces using an adhesive strip affixed to the rear surface of the body. This mounting method provides a secure and stable installation while allowing for the device to be relocated or removed without significant effort or damage to the mounting surface.

In terms of materials, the second embodiment can also be manufactured from a variety of substances such as metals, high-quality plastics, or composites, depending on desired properties such as weight, durability, and appearance. The integration of the magnet within the body is particularly suited for materials that complement the magnetic properties, ensuring a strong and lasting bond between the magnet and the metallic elements of the protective case.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the retention device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A retention device for displaying a protective case, comprising:
a body having a back plate defining a flat vertical surface, a first top end, and an opposing bottom end on the body, wherein the first top end includes at least one first retaining structure for supporting a top edge of the protective case when the protective case is installed flush against the back plate, and the opposing bottom end includes at least one second retaining structure for supporting a bottom edge of the installed protective case, wherein at least one cavity is formed within the back plate; and
at least one magnetic element configured to be installed within the at least one cavity, wherein the at least one magnetic element is positioned to align with a metallic or magnetic element of the protective case when the protective case is installed against the back plate.

2. The retention device of claim 1, further comprising a removable magnetic element, and wherein the at least one cavity is configured to receive the removable magnetic element, allowing for the adjustment of the magnetic element's orientation.

3. The retention device of claim 1, wherein the at least one cavity is an opening in which the at least one magnetic element is permanently installed.

4. The retention device of claim 1, further comprising one or more additional cavities and corresponding magnetic elements to accommodate different styles of protective cases and adjust the level of attractive force between the retention device and the protective case.

5. The retention device of claim 1, wherein the at least one first retaining structure and the at least one second retaining structure include at least one of shelves, ledges, support pegs, or hooks.

6. The retention device of claim 1, wherein the body is made of a material selected from the group consisting of metal and plastic.

7. The retention device of claim 1, wherein the body further comprises a stand, adhesive strip, or other mounting hardware on the opposing side of the back plate for mounting to a wall or other vertical surface.

8. The retention device of claim 1, wherein the body is substantially rectangular and the first top end and the opposing bottom end are configured to support the protective case in a manner that maintains the card as the centerpiece of the display.

9. The retention device of claim 1, wherein the back plate includes an aperture to facilitate manual dislodging of the protective case from the retention device.

10. The retention device of claim 1, further configured to display flat planar objects other than trading card protective cases, including artworks and photographs.

11. The retention device of claim 1, wherein the magnetic elements are composed of neodymium to provide a strong magnetic force for securing the protective case against the back plate.

12. The retention device of claim 1, wherein the body and its components are coated with a corrosion-resistant finish to enhance the longevity and visual appearance of the device.

13. The retention device of claim 1, wherein the body includes parts manufactured from transparent acrylic materials to minimize visual obstruction and maintain focus on the displayed protective case.
